(19) United States
(12) Patent Application Publication
(10) Pub. No.: US 2013/0038933 A1
(43) Pub. Date: Feb. 14, 2013

(54) BEAM SPLITTER AND METHOD FOR MANUFACTURING THE SAME

(71) Applicants: CHIEH-WEN WANG, TAIPEI (TW); WEI-JIE PENG, TAIPEI (TW); WEI-HWA LEE, TAIPEI (TW)

(72) Inventors: CHIEH-WEN WANG, TAIPEI (TW); WEI-JIE PENG, TAIPEI (TW); WEI-HWA LEE, TAIPEI (TW)

(73) Assignees: LITE-ON TECHNOLOGY CORP., TAIPEI (TW); SILITEK ELECTRONIC (GUANGZHOU) CO., LTD., GUANGZHOU (CN)

(21) Appl. No.: 13/342,481

(22) Filed: Jan. 3, 2012

(30) Foreign Application Priority Data
Aug. 9, 2011 (CN) 201110229764.4

(51) Int. Cl. G02B 27/12; B32B 37/14; B23P 17/04; B32B 37/12

(52) U.S. Cl. 359/485.04; 359/640; 156/306.6; 29/458

(57) ABSTRACT

A beam splitter includes a substrate unit, and first and second prisms disposed on surfaces at two opposite sides of the substrate unit, respectively. The substrate unit includes a substrate member, and a beam splitter film disposed at the substrate member and capable of beam splitting. The beam splitter film includes a plurality of thin film layers arranged in a stack. Each of the thin film layers is made of an inorganic material.

### CROSS-REFERENCE TO RELATED APPLICATION

This application claims priority of Chinese Application No. 201110229764.4, filed on Aug. 9, 2011.

### BACKGROUND OF THE INVENTION

1. Field of the Invention

The present invention relates to a beam splitter and a method for manufacturing the same, more particularly to a beam splitter that is applicable to a projector or other optical systems and that is adapted for splitting light with different intensity or different polarization directions, and a method for manufacturing the beam splitter.

2. Description of the Related Art

A beam splitter is used for splitting incident light beams into two portions, and may be classified according to different beam splitting functions as one of a wavelength band (or chromatic) beam splitter, an intensity beam splitter, and a polarization beam splitter. Referring to FIG. 1, a conventional polarization beam splitter 1 includes two prisms 11 bonded with each other, and a beam splitter film 12 disposed between the prisms 11. The beam splitter film 12 is used for reflecting light A1 (S-polarized light) polarized perpendicular to a plane of incidence of incident light A, and for permitting passage of light A2 (P-polarized light) polarized in the plane of incidence of the incident light A, so as to achieve an effect of polarization beam splitting.

During manufacture of the polarization beam splitter 1, a coating process is required to be performed on one of the prism 11 so as to form the beam splitter film 12, and subsequently, the other one of the prisms 11 is adhesively bonded to the prisms 11 formed with the beam splitter film 12 after alignment adjustment. However, since the prisms 11 usually have the shape of a three-dimensional triangular prism, unlike cuboids or plate-shaped articles which are more regular in shape, a specific clamping jig is required for fixing the prisms 11 when forming the beam splitter film 12. Moreover, it is relatively difficult to form the beam splitter film 12 on the prisms 11 with the shape of the triangular prism, and process efficiency is limited when performing the coating process on the prism 11 as a result of the shape of the prisms 11. Therefore, the coating process may not be performed on a large number of the prisms 11 at a time, such that a higher coating cost is incurred, and quality variance of the prisms 11 may not be precisely controlled.

Referring to FIG. 2, a beam splitter 2 disclosed in U.S. Pat. No. 7,329,006 (an embodiment illustrated in FIG. 15 of this prior art) is illustrated. The beam splitter 2 includes a wedge plate 21, a multilayer reflective polarizing beamsplitter (MRPB) film 22, a first prism 23, and a second prism 24. The wedge plate 21 may be formed of glass or polymer and has a gradually increasing thickness from one end to another end of the wedge plate 21. The wedge plate 21 is used for mounting the MRPB film 22 on a surface of the first prism 23, and the second prism 24 is disposed on a surface of the MRPB film 22. In practice, the MRPB film 22 is formed by pulling hundreds of polymer thin films arranged in a stack, and the thin films with high and low refractive indices are alternately arranged in the stack. The MRPB film 22 made of polymer materials has a relatively large thickness of about 223 micrometers as disclosed in the prior art. The thickness of the MRPB film 22 may cause astigmatism in the beam splitter 2, such that the wedge plate 21 with a gradually increasing thickness is required for alleviating astigmatism.

The beam splitter film 22 is not only prone to cause astigmatism, but also has a disadvantage of a complicated manufacturing procedure. The beam splitter film 22 includes hundreds of thin films. The thin films may not be fixedly stacked together simply through bonding strength among the thin films, but through adhesively bonding or thermal melting a stack of the thin films to another stack of the thin films after a predetermined number of thin films are respectively arranged in stacks. Finally, the beam splitter film 22 is formed by repeating the aforementioned steps several times. Therefore, the manufacturing procedure of the beam splitter film 22 is relatively complicated. Furthermore, the polymer material of the beam splitter film 22 has a lower pressure resistance, and may only endure an external stress from one side. When the beam splitter film 22 is compressed at two opposite sides, the thin films of the beam splitter film 22 are prone to separate and delamination of the beam splitter film 22 may occur. In addition, since yellowing of polymer materials may occur as a result of exposure to ultraviolet light and since the polymer materials have lower temperature tolerance, materials thereof are apt to degenerate and functionality thereof deteriorates after the beam splitter has been in use for a period of time.

### SUMMARY OF THE INVENTION

Therefore, an object of the present invention is to provide a beam splitter which is easy to manufacture, which is resistant to ultraviolet light (UV light), heat and delamination, and to provide a method for manufacturing the beam splitter.

Accordingly, the beam splitter of the present invention comprises a substrate unit, and first and second prisms disposed on surfaces at two opposite sides of the substrate unit, respectively. The substrate unit includes a substrate member, and a beam splitter film disposed at the substrate member and capable of beam splitting. The beam splitter film includes a plurality of thin film layers arranged in a stack. Each of the thin film layers is made of an inorganic material.

The method for manufacturing a beam splitter of the present invention comprises the steps of:

(A) providing a substrate unit including a substrate member and a beam splitter film, the beam splitter film being formed by disposing a plurality of thin film layers arranged in a stack at the substrate member by means of vacuum coating, each of the thin film layers being made of an inorganic material; and

(B) disposing first and second prisms on surfaces at two opposite sides of the substrate unit, respectively.

The effect of the present invention resides in that it is much easier to perform a coating process on the planar substrate member compared with performing the coating process on the three-dimensional prisms in the past, and easy manufacturing and a reduced manufacturing cost may be achieved. Moreover, the beam splitter film is made of the inorganic material which has benefits such as heat-resistance, UV light resistance, and pressure-resistance. The thin film layers are stacked to bond directly by means of performing vacuum coating between the thin film layers such that a manufacturing process of this invention is relatively simple.

### BRIEF DESCRIPTION OF THE DRAWINGS

Other features and advantages of the present invention will become apparent in the following detailed description of the two preferred embodiments with reference to the accompanying drawings, of which:

FIG. 1 is a schematic diagram of a conventional polarization beam splitter;

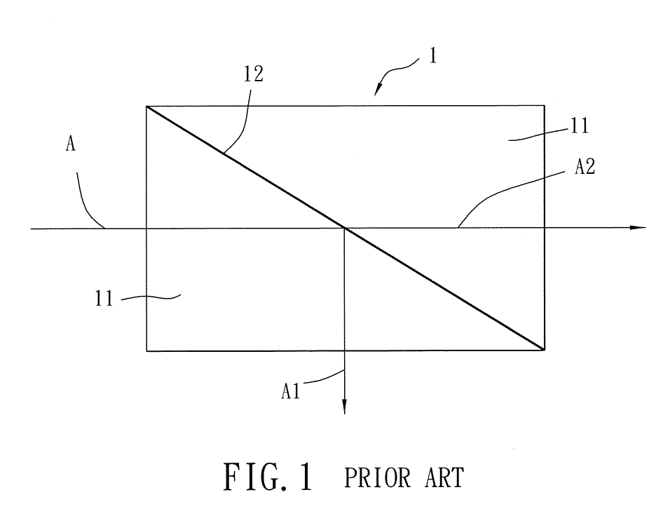

FIG. 2 is a schematic diagram of a beam splitter disclosed in U.S. Pat. No. 7,329,006;

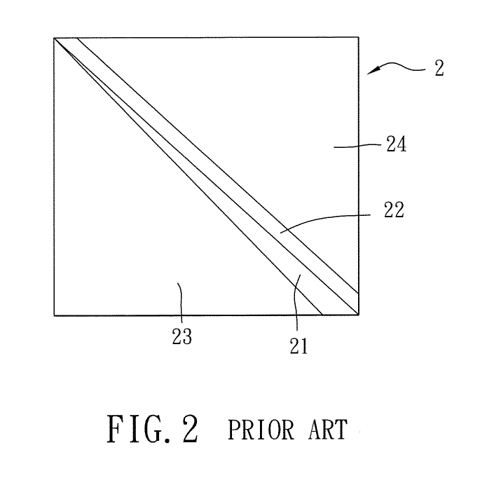

FIG. 3 is a schematic diagram illustrating a first preferred embodiment of a beam splitter of the present invention;

FIG. 4 is a schematic diagram showing a method for manufacturing the first preferred embodiment of the beam splitter according to the present invention, mainly for illustrating procedures for manufacturing the beam splitter shown in FIG. 3; and

FIG. 5 is a schematic diagram illustrating a second preferred embodiment of the beam splitter of the present invention.

### DETAILED DESCRIPTION OF THE PREFERRED EMBODIMENTS

Before the present invention is described in greater detail, it should be noted that like elements are denoted by the same reference numerals throughout the disclosure.

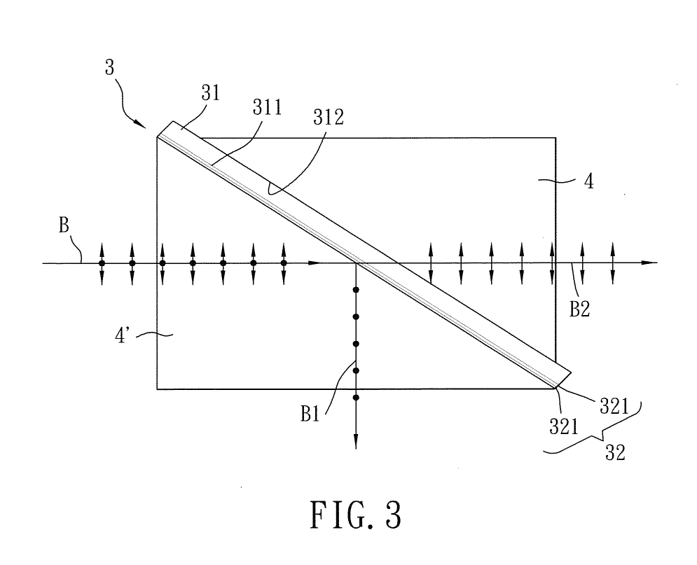

Referring to FIG. 3, a first preferred embodiment of the beam splitter, according to the present invention, is a polarization beam splitter (PBS). This embodiment is applicable to a projector or other optical systems for reflecting light polarized perpendicular to a plane of incidence of incident light (S-polarized light), and for permitting passage of light polarized in the plane of incidence of the incident light (P-polarized light). The beam splitter comprises a substrate unit 3 and first and second prisms 4, 4′ disposed on surfaces at two opposite sides of the substrate unit 3, respectively.

The substrate unit 3 includes a substrate member, and a beam splitter film 32 disposed at the substrate member. In this embodiment, the substrate member includes a substrate 31. The substrate 31 is a transparent, plate-shaped glass substrate, and is made of, for example, a BK7-like glass material. However, the substrate 31 is not limited to the disclosure in this embodiment, and may be made of other materials with higher refractive indices, or may be a plastic substrate 31. The substrate 31 has a first surface 311, and a second surface 312 opposite to the first surface 311.

The beam splitter film 32 is disposed on the first surface 311 of the substrate 31, and includes dozens of thin film layers 321 arranged in a stack (in general, there are 24˜100 layers, and only two layers are illustrated in FIG. 3). The thin film layers 321 are made of at least two kinds of materials, and the thin film layers 321 made of a high refractive index material are alternately arranged with respect to the thin film layers 321 made of a low refractive index material in a stack. Each of the thin film layers 321 has a thickness of about a quarter of a wavelength of the incident light. An effect of beam splitting is achieved by means of the aforementioned arrangement and design.

A material of each of the thin film layers 321 is an inorganic material through which visible light may pass, and may be a dielectric material or a material that is slightly electrically conductive. The advantage of adopting the electrically conductive material resides in conductibility of the beam splitter, but may incur slight absorption of light. Suitable materials of the thin film layers 321 are, for example, oxides, nitrides, sulfides, fluorides, and so forth. Embodiments of the materials are Ta₂O₅, TiO₂, ZnS, SiO₂, MgF₂, cryolites, etc. Since the aforesaid Ta₂O₅, TiO₂ and ZnS have refractive indices greater than those of SiO₂, MgF₂ and cryolites, the beam splitter film 32 may be formed by alternately arranging the materials with the high refractive index with respect to the materials with the low refractive index, such as Ta₂O₅/SiO₂, TiO₂/SiO₂, ZnS/SiO₂, TiO₂/MgF₂, ZnS/MgF₂, etc. Each of the thin film layers 321 may be made of a composite material, so as to produce thin film layers 321 with different refractive indices. For example, TiO₂ may be mixed with Ta₂O₅. Other materials such as ZnO, Al₂O₃, HfO₂, Y₂O₃, ZrO₂ may be adopted for producing the thin film layers 321.

The beam splitter film 32 formed by stacking the thin film layers 321 has an increasing beam splitting ratio as the number of the thin film layers 321 is increased, such that a wavelength bandwidth is widened, i.e., a higher degree of polarization is achieved. Correspondingly, a higher manufacturing cost of the beam splitter is incurred as a result of an increment in thickness and number of the thin film layers 321. However, when the beam splitter film 32 has an excessive thickness, the thin film layers 321 are prone to separate. Therefore, the thickness of the beam splitter film 32 is preferably not larger than 15 micrometers, and more preferably not larger than 5 micrometers.

Materials of the first and second prisms 4, 4′ may be selected from transparent glass and plastic, and the materials of the first and second prisms 4, 4′ may be identical or different. However, when adopting injection molded plastic prisms 4, 4′, an overall uniformity of the refractive index of the plastic material should be considered. The first prism 4 is disposed on the second surface 312 of the substrate 31, and the second prism 4′ is disposed on a surface of the beam splitter film 32. The substrate 31 has a refractive index substantially equal to or different from those of the first and second prisms 4, 4′. When the refractive index of the substrate 31 is equal to those of the first and second prisms 4, 4′, they may be made of an identical material, and light beams may not be refracted when passing through the first prism 4 from the substrate 31. The first and second prisms 4, 4′ are used for optical path compensation, so as to achieve effects of astigmatism adjustment and aberration reduction.

When the incident light B passes through the second prism 4′ and reaches a boundary between the second prism 4′ and the beam splitter film 32 at the Brewster's angle, S-polarized light B1 of the incident light B is reflected by the beam splitter film 32 and P-polarized light B2 of the incident light B is permitted to pass through the beam splitter film 32 and to exit the substrate 31 and the first prism 4. In this way, an effect of beam splitting is achieved. It should be noted that, in FIG. 3, the incident light B and the P-polarized light B2 are collinear, but in practice, the P-polarized light B2 may be slightly refracted when components in the beam splitter have different refractive indices.

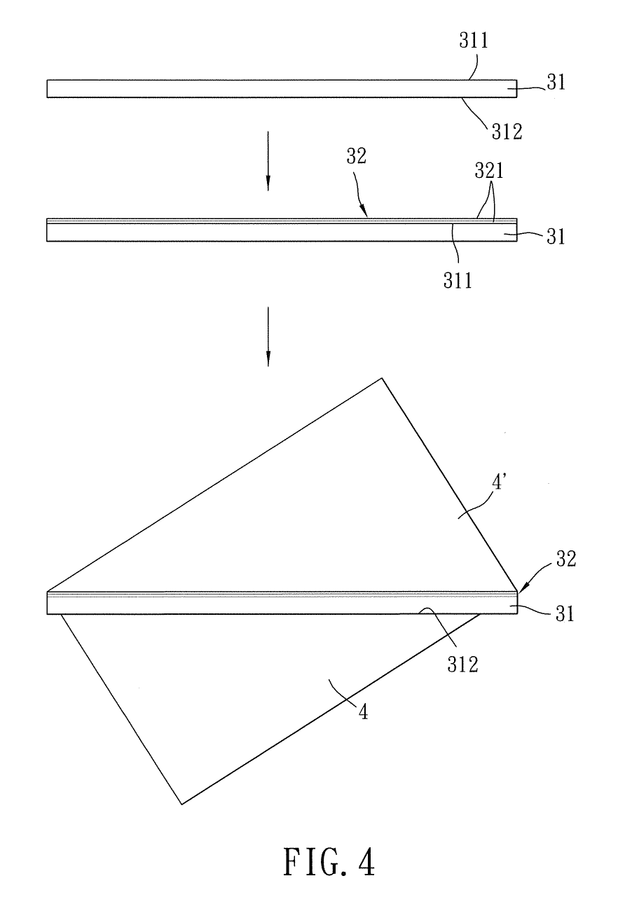

Referring to FIG. 3 and FIG. 4, a preferred embodiment of the method for manufacturing the beam splitter, according to the present invention, comprises steps of:

(A) providing the substrate unit 3 including the substrate 31 and the beam splitter film 32. In this step, the beam splitter film 32 is formed by disposing a plurality of the thin film layers 321 arranged in a stack on the first surface 311 of the substrate 31 by means of vacuum coating, such as evaporation deposition or sputter deposition. The beam splitter film 32 is made with the thickness not larger than 15 micrometers, and since the materials of the thin film layers 321 have been recited hereinabove, details of the same are omitted herein for the sake of brevity.

(B) disposing first and second prisms on surfaces at two opposite sides of the substrate unit, respectively. An embodiment of this step is to adhesively bond the first prism 4 onto the second surface 312 of the substrate 31, and to adhesively bond the second prism 4′ onto the surface of the beam splitter film 32. A method of adhesive bonding is to apply ultraviolet (UV) light curable adhesive on the second surface 312 of the substrate 31 and the surface of the beam splitter film 32, and to cure the UV light curable adhesive by irradiation with ultraviolet light, such that the first and second prisms 4, 4′ and the substrate unit 3 are bonded together.

In summary, it is much easier to perform a coating process on the substrate 31 that is laid flat in the present invention compared with performing the coating process on prisms, which are three-dimensional in shape. Therefore, a large area coating process may be adopted for forming the beam splitter film 32 by means of evaporation deposition or sputter deposition, so as to reduce manufacturing time and cost, and to reduce thin film variance among beam splitters so as to maintain stable quality thereof.

Compared with the prior art disclosed in U.S. Pat. No. 7,329,006, the beam splitter film 32 of the present invention is made of inorganic material, and is formed by stacking a plurality of the thin film layers 321.

This step may be implemented through deposition of the thin film layers 321 by a vacuum coating technique in the semiconductor process. Since the vacuum coating technique is quite mature, quality and the thickness of the deposited beam splitter film 32 may be easily controlled, so as to achieve the effect of beam splitting. Moreover, the thin film layers 321 formed through the vacuum coating technique may be directly arranged in the stack without requiring additional fixing means such as adhesive bonding or thermal melting, such that the beam splitter of the present invention may be manufactured with relative ease. The beam splitter film 32 made of inorganic material is relatively heat-resistant, and is resistant to irradiation of UV light so as to lessen adverse influence resulting from light and heat upon film quality. Further, the beam splitter film 32 is relatively resistant to pressure, and hardly delaminates after compression. In addition, the thickness of the beam splitter film 32 is small enough to alleviate an issue of astigmatism. Therefore, the present invention may overcome the aforesaid drawbacks of the prior art.

It should be noted that the present invention is not limited to application of polarization beam splitters since cooperative structures of the aforementioned substrate 31, the beam splitter film 32, and the first and second prisms 4, 4′ maybe applicable to an intensity beam splitter. The intensity beam splitter may split light beams into two portions according to light intensity ratios. Certainly, a design of the beam splitter film in the intensity beam splitter may be distinct, and may only achieve the effect of beam splitting upon satisfying a specific beam splitting condition. Since the feature of the present invention does not reside in the detailed configuration of the design of the beam splitter film in the intensity beam splitter, further details of the same are omitted herein for the sake of brevity.

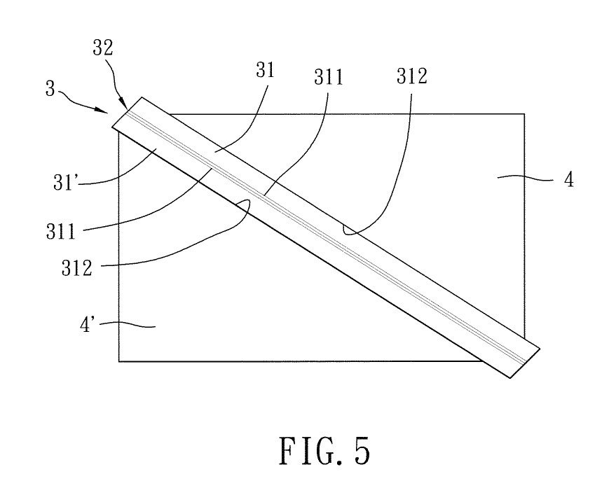

Referring to FIG. 5, a second preferred embodiment of the beam splitter of the present invention is substantially similar to the first preferred embodiment. The second preferred embodiment differs from the first preferred embodiment in the configuration that the substrate member of this embodiment includes a first substrate 31 and a second substrate 31′. Each of the first and second substrates 31, 31′ has a first surface 311 disposed to face the other one of the first and second substrates 31, 31′, and a second surface 312 opposite to the first surface 311. In this embodiment, the beam splitter film 32 is disposed between the first surfaces 311 of the first and second substrates 31, 31′. Each of the first and second prisms 4, 4′ is disposed on the second surface 312 of a respective one of the first and second substrates 31, 31′.

During manufacture of this embodiment, the beam splitter film 32 is disposed on the first surface 311 of the first substrate 31 through the vacuum coating technique. Subsequently, the second substrate 31′ is disposed on the beam splitter film 32 with the first surface 311 of the second substrate 31′ facing the beam splitter film 32, and the second substrate 31′ is adhesively bonded to the first substrate 31 by using the UV light curable adhesive with the beam splitter film 32 disposed between the first and second substrates 31, 31′. Finally, the first and second prisms 4, 4′ are adhesively bonded to the second surfaces 312 of the first and second substrates 31, 31′, respectively, by using the UV light curable adhesive, and the manufacturing process is completed.

The substrate unit 3 of this embodiment may be produced in another way comprising steps of providing a large area substrate (not shown) applied with a plurality of thin film layers, cutting the large area substrate with the thin film layers into two equal area substrates, disposing the two substrates with the thin film layers facing each other, and adhesively bonding the two substrates with the thin film layers disposed between the two substrates, so as to complete assembly of the first substrate 31, the beam splitter film 32, and the second substrate 31′ in the present invention.

In this embodiment, the substrate unit 3 includes two symmetric first and second substrates 31, 31′. That is, the beam splitter in this embodiment is substantially symmetrical with respect to the beam splitter film 32, such that the reflected light (S-polarized light) of the incident light has an optical path length substantially equal to that of the permitted light (P-polarized light) of the incident light. It should be noted that since the substrate unit 3 of the first preferred embodiment in FIG. 3 does not have a symmetric structure, the first and second prisms 4, 4′ in FIG. 3 have different sizes so as to compensate for optical path difference between the reflected light and the permitted light.

Since the effect of beam splitting and advantages of this embodiment are substantially the same with those of the first preferred embodiment, details of the same are omitted herein for the sake of brevity.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A beam splitter comprising:
a substrate unit including a substrate member, and a beam splitter film disposed at said substrate member and capable of beam splitting, said beam splitter film including a plurality of thin film layers arranged in a stack, each of said thin film layers being made of an inorganic material; and
first and second prisms disposed on surfaces at two opposite sides of said substrate unit, respectively.

2. The beam splitter as claimed in claim 1, wherein said substrate member includes a substrate, said substrate having a first surface for disposition of said beam splitter film, and a second surface opposite to said first surface; and
wherein said first prism is disposed on said second surface of said substrate, and said second prism is disposed on a surface of said beam splitter film.

3. The beam splitter as claimed in claim 1, wherein said substrate member includes a first substrate and a second substrate, each of said first and second substrates having a first surface disposed to face the other one of said first and second substrates, and a second surface opposite to said first surface; and
wherein said beam splitter film is disposed between said first surfaces of said first and second substrates, and each of said first and second prisms is disposed on said second surface of a respective one of said first and second substrates.

4. The beam splitter as claimed in claim 1, wherein said beam splitter film has a thickness not larger than 15 micrometers.

5. The beam splitter as claimed in claim 4, wherein the thickness of said beam splitter film is not larger than 5 micrometers.

6. The beam splitter as claimed in claim 1, wherein each of said thin film layers is made of an inorganic dielectric material.

7. The beam splitter as claimed in claim 1, wherein said substrate member has a refractive index substantially equal to those of said first and second prisms.

8. The beam splitter as claimed in claim 1, wherein said beam splitter is a polarization beam splitter capable of reflecting S-polarized light and permitting passage of P-polarized light.

9. A method for manufacturing a beam splitter, comprising the steps of:
(A) providing a substrate unit including a substrate member and a beam splitter film, the beam splitter film being formed by disposing a plurality of thin film layers arranged in a stack at the substrate member by means of vacuum coating, each of the thin film layers being made of an inorganic material; and
(B) disposing first and second prisms on surfaces at two opposite sides of the substrate unit, respectively.

10. The method as claimed in claim 9, wherein the substrate member includes a substrate, the beam splitter film is formed on a first surface of the substrate, and step (B) includes disposing the first prism on a second surface of the substrate opposite to the first surface thereof, and disposing the second prism on a surface of said beam splitter film.

11. The method as claimed in claim 9, wherein the substrate member includes first and second substrates, each of the first and second substrates having a first surface disposed to face the other one of the first and second substrates, and a second surface opposite to the first surface, step (A) including forming the beam splitter film between the first surfaces of the first and second substrates, step (B) including disposing each of the first and second prisms on the second surface of a respective one of the first and second substrates.

12. The method as claimed in claim 9, wherein the first and second prisms are adhesively bonded to the substrate unit.

13. The method as claimed in claim 9, wherein the beam splitter film has a thickness not larger than 15 micrometers.

14. The method as claimed in claim 13, wherein the thickness of the beam splitter film is not larger than 5 micrometers.

15. The method as claimed in claim 9, wherein each of the thin film layers is made of an inorganic dielectric material.

16. The method as claimed in claim 9, wherein the substrate member has a refractive index substantially equal to those of the first and second prisms.

17. The method as claimed in claim 9, wherein the beam splitter is a polarization beam splitter capable of reflecting S-polarized light and permitting passage of P-polarized light.
